(19) United States
(12) Patent Application Publication
(10) Pub. No.: US 2025/0086990 A1
(43) Pub. Date: Mar. 13, 2025

(54) ONBOARD DEVICE, DRIVING RECORDING METHOD, AND DRIVING RECORDING SYSTEM

(71) Applicant: JVCKENWOOD Corporation, Yokohama-shi (JP)

(72) Inventors: Takayuki SATO, Yokohama-shi (JP); Tomoki SAKURAGI, Yokohama-shi (JP); Masami NAKAMURA, Yokohama-shi (JP)

(21) Appl. No.: 18/955,041

(22) Filed: Nov. 21, 2024

Related U.S. Application Data
(63) Continuation of application No. PCT/JP2023/018845, filed on May 19, 2023.

(30) Foreign Application Priority Data
Jun. 24, 2022 (JP) 2022-102071

(51) Int. Cl. G06V 20/62; G06V 20/58

(52) U.S. Cl. CPC G06V 20/625; G06V 20/58; G06V 2201/08

(57) ABSTRACT

There is provided an onboard device that records an event by using a camera installed in a surrounding vehicle. The onboard device includes an image capturing unit that captures an image of at least a license plate of a surrounding vehicle from a subject vehicle, a license plate recognition unit that recognizes license plate information from the license plate of the surrounding vehicle that is captured, an event information detection unit that detects event information of the subject vehicle, and a transmission unit that transmits the license plate information of the surrounding vehicle, and transmits the event information of the subject vehicle for causing control to be performed such that the surrounding vehicle that is identified is caused to record an event image.

### CROSS REFERENCE TO RELATED APPLICATION

This application is based upon and claims the benefit of priority from International Patent Application No. PCT/JP2023/018845, filed on May 19, 2023, which is based on Japanese Patent Application No. 2022-102071, filed on Jun. 24, 2022, the disclosure of which is incorporated herein in its entirety by reference.

### BACKGROUND

The present invention relates to an onboard device, a driving recording method, and a driving recording system.

Onboard devices for recording an image immediately before an accident have been developed. Patent Literature 1 describes an onboard device where image information from a CCD (charge-coupled device) camera and sensor information from each of a vehicle speed sensor 3 to an accelerometer 6 are simultaneously recorded in a random access memory 12 due to control by a control circuit 11. Furthermore, recorded information in the random access memory 12 is transferred to a flash memory 13 when a collision sensor 2 is operated and is taken out from an output terminal 15 via an encoder 14, and image information immediately before an accident is reproduced.

Patent Literature 1: Japanese Unexamined Patent Application Publication No. 2000-6854

### SUMMARY

In the above-mentioned literature, image capturing was assumed to be performed by a camera mounted in a subject vehicle. Conventionally, only a forward camera was available, but onboard devices capable of capturing a rear side, inside of a vehicle cabin, and surrounding 360 degrees have come to be used.

However, due to camera performance such as lens performance, sensor resolution, exposure time and the like, image blurring, rolling shutter distortion, overexposure, and angle of view limitation were caused. Accordingly, it was not possible to record every aspect of an event such as an accident, and, for example, it was not possible to reliably record a crashed license plate just by using a camera installed in a subject vehicle.

An onboard device of the present disclosure is an onboard device including:
an image capturing unit that captures an image of at least a license plate of a surrounding vehicle from a subject vehicle;
a license plate recognition unit that recognizes license plate information from the license plate of the surrounding vehicle that is captured;
an event information detection unit that detects event information of the subject vehicle; and
a transmission unit that transmits the license plate information of the surrounding vehicle, and transmits the event information of the subject vehicle for causing control to be performed such that the surrounding vehicle identified by the control unit is caused to record an event image.

A driving recording method of the present disclosure is a driving recording method including:
a step of at least capturing a license plate of a surrounding vehicle from a subject vehicle;
a step of recognizing license plate information from the license plate of the surrounding vehicle that is captured;
a step of detecting event information of the subject vehicle;
a step of transmitting the event information of the subject vehicle and the license plate information of the surrounding vehicle to a control unit of a server; and
a step of transmitting the license plate information of the surrounding vehicle, identifying the surrounding vehicle from the license plate information of the surrounding vehicle, and transmitting the event information of the subject vehicle for causing control to be performed such that the surrounding vehicle that is identified is caused to record an event image.

A driving recording system of the present disclosure is a driving recording system including:
an image capturing unit that captures an image of at least a license plate of a surrounding vehicle from a subject vehicle;
a license plate recognition unit that recognizes license plate information from the license plate of the surrounding vehicle that is captured;
an event information detection unit that detects event information of the subject vehicle;
a transmission unit that transmits the event information of the subject vehicle and the license plate information of the surrounding vehicle to a control unit of a server;
the control unit of the server, the control unit identifying the surrounding vehicle from the license plate information of the surrounding vehicle that is transmitted, and performing control such that the surrounding vehicle that is identified is caused to record an event image of the subject vehicle; and
a recording unit that records, in a non-transitory manner, the event image that is recorded by the surrounding vehicle.

### BRIEF DESCRIPTION OF THE DRAWINGS

FIG. 1 is a block diagram of an onboard device according to an embodiment;

FIG. 2 is a schematic diagram of a driving recording system according to the embodiment;

FIG. 3 is a flowchart of a driving recording method according to the embodiment;

FIG. 4 is a diagram according to the embodiment, showing surrounding vehicles in an accident occurring at a time of a right turn from a priority lane;

FIG. 5 is a diagram according to the embodiment, showing surrounding vehicles in an accident occurring at a time of a right turn from a priority lane;

FIG. 6 is a diagram according to the embodiment, showing surrounding vehicles in an accident occurring at a time of a left turn from a non-priority lane; and

FIG. 7 is a diagram according to the embodiment, showing surrounding vehicles in an accident occurring at a time of a left turn from a non-priority lane.

### DETAILED DESCRIPTION

Hereinafter, an embodiment of the present invention will be described with reference to the drawings. However, the invention according to the claims is not limited to the following embodiment. Furthermore, not all the components described in the embodiment are essential as means for solving the problem. For the clarity of description, the following description and drawings are omitted and simplified as appropriate. In the drawings, the same elements are denoted by the same reference sign, and redundant description is omitted as necessary.

### Description of Onboard Device and Driving Recording System According to Embodiment

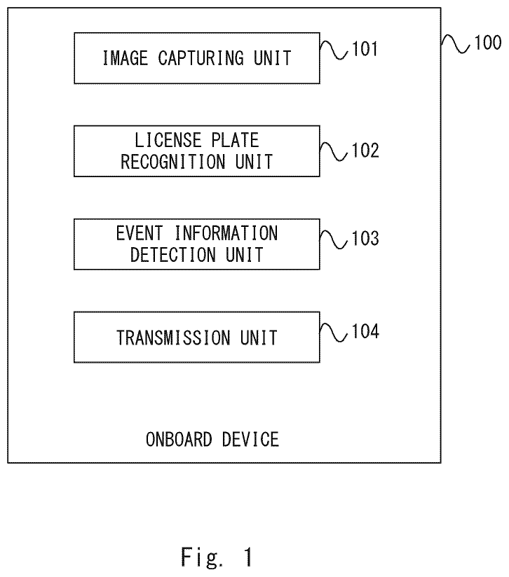

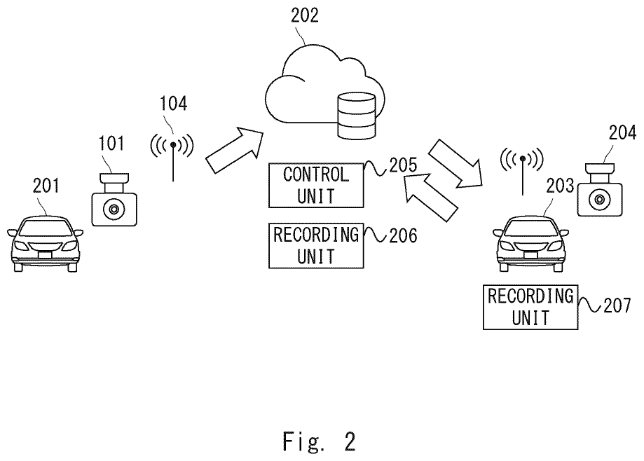

FIG. 1 is a block diagram of an onboard device according to an embodiment. FIG. 2 is a schematic diagram of a driving recording system according to the embodiment. The onboard device and the driving recording system according to the embodiment will be described with reference to FIGS. 1 and 2.

As shown in FIG. 1, an onboard device 100 according to the embodiment includes an image capturing unit 101, a license plate recognition unit 102, an event information detection unit 103, and a transmission unit 104. As shown in FIGS. 1 and 2, the driving recording system according to the embodiment includes the onboard device 100 including the image capturing unit 101, the license plate recognition unit 102, the event information detection unit 103 and the transmission unit 104, a subject vehicle 201, a server 202, a surrounding vehicle 203, a dashboard camera 204, a control unit 205, a recording unit 206, and a recording unit 207.

As the image capturing unit 101, a CCD camera or a CMOS (Complementary Metal Oxide Semiconductor) image sensor may be used, for example. As the image capturing unit 101, a dashboard camera mounted in the subject vehicle 201 may be used. The image capturing unit 101 at least captures an image of a license plate of the surrounding vehicle 203 from the subject vehicle 201. Accordingly, the image capturing unit 101 preferably has a wide image capturing range. The image capturing unit 101 is preferably able to capture not only an image of a front side, but also images of inside a vehicle cabin and a rear side. Particularly, the image capturing unit 101 is preferably able to capture an image of every direction across 360 degrees including a lateral direction. Additionally, a video includes a plurality of chronological images (also referred to as frames), and thus, a video and an image are terms that may be used interchangeably.

The license plate recognition unit 102 is a part that includes a function of recognizing license plate information. The license plate recognition unit 102 includes image analysis by AI (Artificial Intelligence). The license plate recognition unit 102 at least recognizes the part of a license plate from a captured surrounding vehicle 203. The license plate recognition unit 102 may recognize the number on the license plate by image analysis. The license plate information may be numbers and letters described on the license plate recognized by image analysis, or may be an image obtained by recognizing a position of the license plate and cutting out only the corresponding part.

The event information detection unit 103 detects event information of the subject vehicle 201. The event information can be acquired from various sensors such as an accelerometer and a speed sensor, and based on analysis of an image from a dashboard camera. For example, the accelerometer detects an impact of a car collision. Furthermore, an environmental sensor (a radio wave sensor, an optical sensor, an event-based vision sensor, an acoustic wave sensor) detects a car break-in. Furthermore, analysis of an image from the dashboard camera by AI detects tailgating. In this manner, the event information detection unit 103 detects events that occur in relation to the subject vehicle 201, such as an impact of an accident and tailgating. Moreover, the event information includes time information such as an event occurrence time.

The transmission unit 104 is a part that includes a function of transmitting the event information of the subject vehicle 201 and the license plate information of the surrounding vehicle 203 to the control unit 205 of the external server 202 when the event information is detected. The transmission unit 104 is capable of transmitting the event information and the license plate information by using an existing network. Existing networks are mobile phone lines compatible with LTE (Long Term Evolution), 4G (4th Generation), 5G (5th Generation) and the like, internet connections that use Wi-Fi and Bluetooth (registered trademark), VICS (Vehicle Information and Communication System; registered trademark), and the like. The transmission unit 104 transmits the event information to the control unit 205 that identifies the surrounding vehicle 203 from the license plate information that is received, that acquires a record of the dashboard camera 204, and that performs control such that records acquired by the recording units 206, 207 are recorded.

Functions of the onboard device 100 may be implemented by one apparatus, or may be implemented by a plurality of apparatuses where the functions are distributed. In the case where a plurality of apparatuses are used, the apparatuses are combined into one onboard device 100.

The subject vehicle 201 is a vehicle that is driven by a driver. The onboard device 100 is mounted in the subject vehicle 201.

As the server 202, a computer including a CPU (Central Processing Unit), a ROM (Read Only Memory), a RAM (Random Access Memory), a hard disk, an I/O (Input/Output) interface, and the like may be used. The server 202 may be configured by one apparatus, or may be configured by a plurality of apparatuses. Furthermore, the server 202 may be partly or wholly disposed in edge or cloud. Moreover, functions of the server 202 may be distributed in the cloud. The event information is transmitted from a plurality of vehicles to the server 202 via a network. The server 202 is installed at a position away from the subject vehicle 201. As the server 202, a server that is installed by an insurance company to monitor an accident that is recorded by the dashboard camera 204 can be used.

The surrounding vehicle 203 is a vehicle existing in surroundings of the subject vehicle 201. The surrounding vehicle 203 includes vehicles that are on the same lane as the subject vehicle 201 and that are in front of and behind the subject vehicle 201, oncoming vehicles, and vehicles that pass by the subject vehicle 201 at an intersection. There may be one or more surrounding vehicles 203.

The dashboard camera 204 is a dashboard camera that is mounted in the surrounding vehicle 203. The dashboard camera 204 captures an image of the surroundings of the surrounding vehicle 203. Accordingly, an image of the subject vehicle 201 can be captured. Like the onboard device 100, the dashboard camera 204 is connected to a network by a transmission/reception unit. That is, the onboard device 100, the server 202, and the dashboard camera 204 are connected via a network. Additionally, the onboard device 100 and the server 202, and the server 202 and the dashboard camera 204 may be connected via the same network or via different networks. The dashboard camera 204 is connected to the control unit 205 of the server 202 via the network, and can be controlled by the control unit 205. A record in the dashboard camera 204 is a temporary record recorded in a ring buffer.

The control unit 205 of the server 202 is a CPU, for example. The license plate information is transmitted to the control unit 205, together with the event information. The control unit 205 identifies the surrounding vehicle 203 based on the license plate information. The control unit 205 performs control such that the identified surrounding vehicle 203 records, using the dashboard camera 204, an event image that is generated based on an event of the subject vehicle 201. The dashboard camera 204 is controlled after the event, but acquisition of a pre-event record in the dashboard camera 204 is also included in the control for causing an event image to be recorded by the dashboard camera 204. That is, controlling the surrounding vehicle 203 to record an event image of the subject vehicle 201 includes retrospectively acquiring, after an event, an image of the event that is recorded in the dashboard camera 204.

The recording unit 206 is a medium that is included in the server 202 and that records a record in the dashboard camera 204 in a non-transitory manner. The recording unit 206 may be a magnetic recording medium (such as a floppy disk, a magnetic tape, or a hard disk drive), a magneto-optical recording medium (such as a magneto-optical disk), a CD-R, a CD-R/W, or a semiconductor memory. The recording unit 206 is capable of recording the event image in a non-transitory manner.

The recording unit 207 is a medium that is included in the dashboard camera 204 and that records, in a non-transitory manner, a record in the dashboard camera 204. The recording unit 207 may be a hard disk drive or a memory card. The recording unit 207 is capable of recording the event image in a non-transitory manner.

The control unit 205 performs control such that the event image recorded by the dashboard camera 204 of the surrounding vehicle 203 is recorded in the non-transitory recording unit 206, 207. As described above, the recording unit 206, 207 may be installed in the server 202 or in the surrounding vehicle 203. The recording unit 206, 207 may be installed in one or both of the server 202 and the surrounding vehicle 203. In the case where a record in the dashboard camera 204 is to be written in the recording unit 206 of the server 202, the recording unit 206 is desirable because there is no interference from a third party. In the case where write is performed in the non-transitory recording unit 207 included in the dashboard camera 204, the surrounding vehicle 203 and its owner are identified, and thus, a driver of the subject vehicle 201 can negotiate with the owner and collect the recording unit 207 or the data therein. It is sometimes grasped in a database of an insurance company whether a dashboard camera is mounted in an insured vehicle. Accordingly, an image of an accident may be provided to the driver of the subject vehicle 201 via the insurance company.

With the onboard device 100 and the driving recording system as described above, an event may be recorded using not only a camera installed in the subject vehicle 201 but also the camera (the dashboard camera 204) installed in the surrounding vehicle 203. Accordingly, information can be collected in an exhaustive and extensive manner. For example, in the case where the subject vehicle 201 is hit and run, even if the license plate of an offending vehicle is not in the dashboard camera of the subject vehicle 201, the driver can grasp that a site of the accident is captured by the dashboard camera 204 of the surrounding vehicle 203. According to the present embodiment, there can be provided an onboard device that records an event by using not only the camera installed in the subject vehicle but also the camera (the dashboard camera) installed in the surrounding vehicle.

### Description of Driving Recording Method According to Embodiment

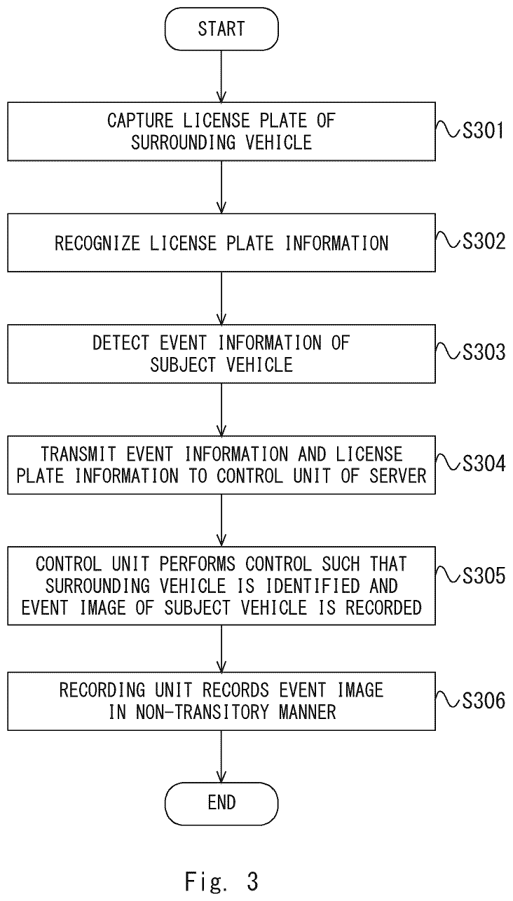

FIG. 3 is a flowchart of a driving recording method according to the embodiment. The driving recording method according to the embodiment will be described with reference to FIG. 3.

First, the license plate information of the surrounding vehicle 203 is captured (step S301). That is, at least the license plate of the surrounding vehicle 203 is captured from the subject vehicle 201. Normally, the image capturing unit 101 captures an image of the surrounding vehicle 203 including a scene and the license plate.

Next, the license plate information is recognized (step S302). The license plate information is recognized from the license plate of the surrounding vehicle 203 that is captured. Numbers and letters described on the license plate may be recognized by image analysis. Furthermore, the control unit 205 may recognize the numbers and the letters described on the license plate when the license plate information is transmitted to the control unit 205.

Next, the event information of the subject vehicle 201 is detected (step S303). Occurrence of an event is rare. Accordingly, detection of the event information is preferably performed using not a dedicated sensor but a speed sensor, an accelerometer or the like that is mounted in the subject vehicle 201 for other purposes.

In a case where an event is detected, the event information and the license plate information are transmitted to the control unit 205 of the server 202 (step S304). That is, when the event information is detected, the event information of the subject vehicle 201 and the license plate information of the surrounding vehicle 203 are transmitted to the control unit 205 of the server 202.

Next, the control unit 205 performs control such that the surrounding vehicle 203 is identified and the event image of the subject vehicle 201 is recorded (step S305). That is, when the event information of the subject vehicle 201 is transmitted to the control unit 205 of the server 202, the control unit 205 identifies the surrounding vehicle 203 based on the license plate information of the surrounding vehicle 203 that is transmitted. Then, the control unit 205 controls the dashboard camera 204 of the identified surrounding vehicle 203 such that the surrounding vehicle 203 records the event image showing a state of the event of the subject vehicle 201 in the dashboard camera 204 or the like.

Lastly, the recording unit 206, 207 records the event image in a non-transitory manner (step S306). A record in the dashboard camera 204 itself is overwritten, and thus, has to be written in the recording unit 206, 207 that is capable of performing saving in a non-transitory manner. The process is then ended.

With the driving recording method as described above, an event can be recorded using not only the camera installed in the subject vehicle 201 but also the camera (the dashboard camera 204) installed in the surrounding vehicle 203.

Here, the license plate information of the surrounding vehicle 203 is recognized before the event information is detected, and the license plate information recognized before detection of the event information is transmitted to the control unit 205 at the time of occurrence of the event. By transmitting the event information only at the time of occurrence of the event, unnecessary information can be prevented from being transmitted. Furthermore, by recognizing the license plate information before the event information is detected, a preparation for transmitting the license plate information can be made. In the case of recognizing the license plate information of the surrounding vehicle 203 before the event information is detected, the license plate information preceding the event by a certain period of time is updated. That is, the license plate information is recorded in a ring buffer. The license plate information that is recorded at the time of occurrence of the event is used.

It is also possible to recognize the license plate information of the surrounding vehicle 203 after the event information is detected, and to transmit the license plate information recognized after detection of the event information to the control unit 205. This allows even more useful information to be obtained. However, recognition of the license plate information is desirably performed from before detection of the event information. This allows a preparation for transmission of the license plate information to be made.

### Description of Surrounding Vehicle in Accident According to Embodiment

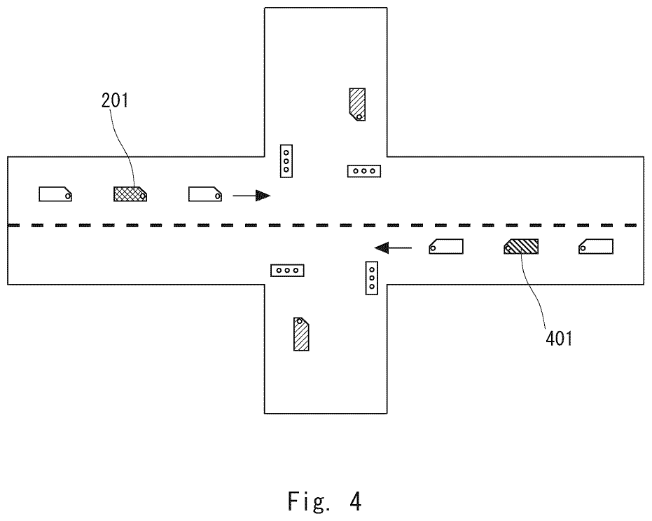

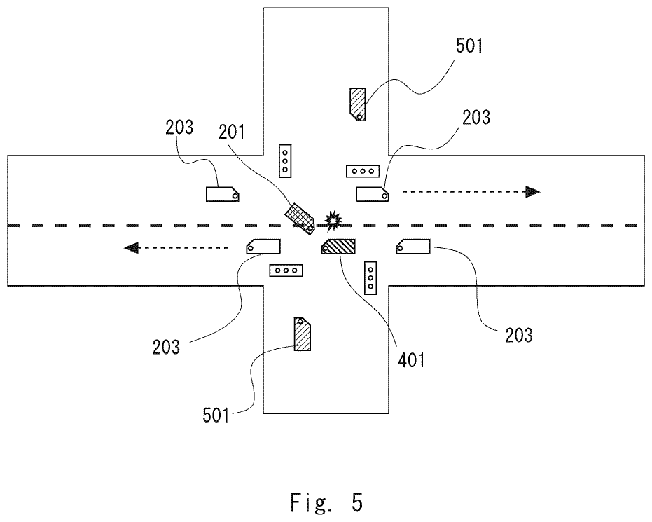

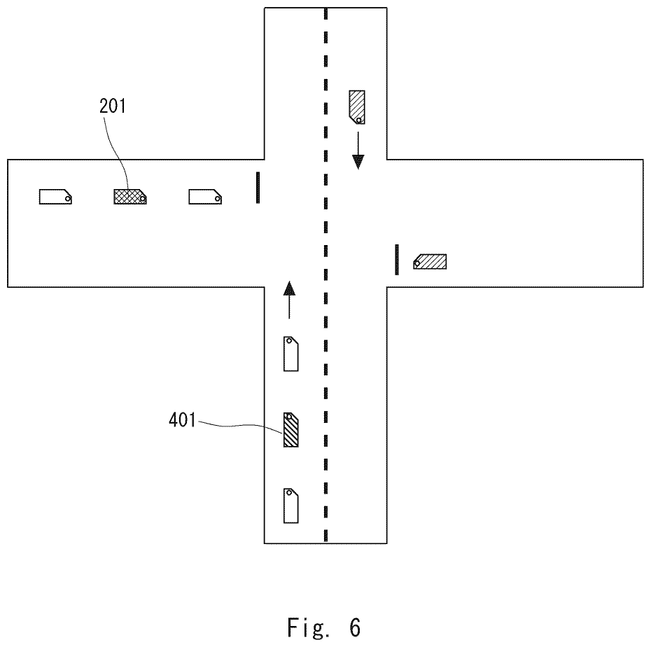

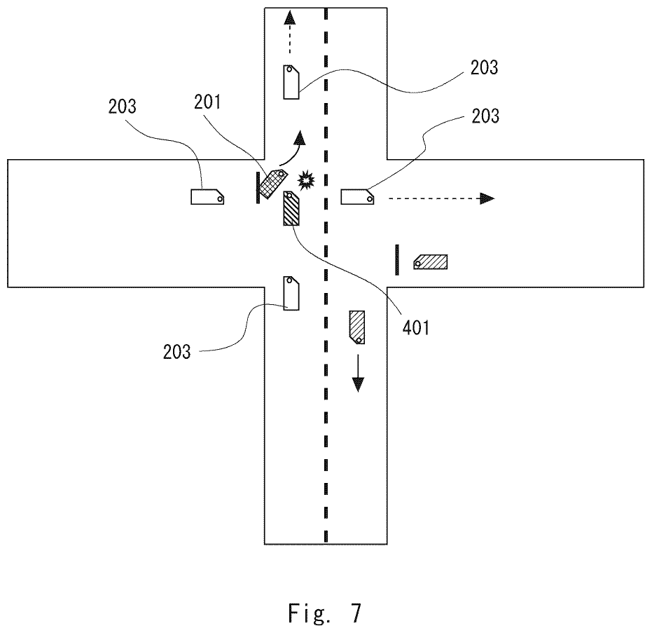

FIG. 4 is a diagram according to the embodiment, showing surrounding vehicles in an accident occurring at a time of a right turn from a priority lane. FIG. 5 is a diagram according to the embodiment, showing surrounding vehicles in an accident occurring at a time of a right turn from a priority lane. FIG. 6 is a diagram according to the embodiment, showing surrounding vehicles in an accident occurring at a time of a left turn from a non-priority lane. FIG. 7 is a diagram according to the embodiment, showing surrounding vehicles in an accident occurring at a time of a left turn from a non-priority lane. Surrounding vehicles in an accident according to the embodiment will be described with reference to FIGS. 4 to 7.

As shown in FIG. 4, it is assumed that the subject vehicle 201 and another vehicle 401 are traveling in opposite directions on priority lanes. As shown in FIG. 5, it is assumed that the subject vehicle 201 collides into the other vehicle 401 at the time of turning right. Here, the license plate information of the surrounding vehicles 203 that are in the surroundings of the subject vehicle 201 and that are shown in white is recognized before the accident. Accordingly, a state of the accident is captured using the dashboard cameras 204 of the surrounding vehicles 203.

Here, as the surrounding vehicles 203, vehicles having the license plate information that can be recognized before the accident, namely, vehicles traveling on the same lane and oncoming vehicles, are shown. However, vehicles 501 that are shown with hatching and that are waiting at a traffic line on non-priority lanes may be included as the surrounding vehicles 203 that are to capture an event and whose license plate information is to be recognized after the accident. If a camera for capturing a lateral side is attached to the subject vehicle 201, such a vehicle 501 may be selected as the surrounding vehicle 203. A video from which direction is needed may be estimated and determined based on sensor information. For example, in the case where the other vehicle 401 collided into a left side of the subject vehicle 201, a vehicle including the dashboard camera 204 that possibly captured the scene is identified.

Furthermore, the dashboard camera mounted in the subject vehicle 201 may constantly provide information from GPS or the accelerometer to the server. In this case, a vehicle or a camera that was capable of performing image capturing can be identified based on position information (GPS: global positioning system) and orientation information of the vehicle. The license plate information of an oncoming vehicle that was at a faraway position before the event can be excluded from targets so that irrelevant images are not collected.

As shown in FIG. 6, it is assumed that the subject vehicle 201 is traveling on a non-priority lane, and the other vehicle 401 is traveling on a priority lane. As shown in FIG. 7, it is assumed that the subject vehicle 201 collides into the other vehicle 401 at a time of turning left. In this case, the accident can be captured by the dashboard cameras 204 of the surrounding vehicles 203 that are in the surroundings of the subject vehicle 201 and that are shown in white. They are vehicles traveling on the same lanes as the subject vehicle 201 and the other vehicle 401. Vehicles that are traveling on the same lanes as the subject vehicle 201 and the other vehicle 401 and that are traveling away from the site of the accident are also capable of capturing useful information.

Furthermore, a part or all of the processes by the onboard device 100 and the server 202 described above can be implemented as a computer program. Such a program can be stored in any type of non-transitory computer-readable medium to be supplied to a computer. The non-transitory computer-readable media include any type of tangible recording media. Examples of the non-transitory computer-readable medium include magnetic recording media (such as floppy disks, magnetic tapes, and hard disk drives), magneto-optical recording media (such as magneto-optical disks), CD-ROM (Read Only Memory), CD-R, CD-R/W, and semiconductor memories (such as mask ROM, PROM (Programmable ROM), EPROM (Erasable PROM), flash ROM, and RAM (Random Access Memory)). Moreover, the program may be supplied to a computer by any type of transitory computer-readable medium. Examples of the transitory computer-readable medium include electric signals, optical signals, and electromagnetic waves. The transitory computer-readable media can supply the program to a computer via a wired communication line such as an electric wire or an optical fiber, or a wireless communication line.

Additionally, the present invention is not limited to the embodiment described above, and changes can be made as appropriate within the scope of the invention.

According to the present embodiment, an image of an accident can be recorded using an onboard device mounted in a vehicle.

What is claimed is:

1. An onboard device comprising:
an image capturing unit that captures an image of at least a license plate of a surrounding vehicle from a subject vehicle;
a license plate recognition unit that recognizes license plate information from the license plate of the surrounding vehicle that is captured;
an event information detection unit that detects event information of the subject vehicle; and
a transmission unit that transmits the license plate information of the surrounding vehicle to a control unit, and transmits the event information of the subject vehicle for causing control to be performed such that the surrounding vehicle identified by the control unit is caused to record an event image.

2. The onboard device according to claim 1, wherein
the license plate recognition unit recognizes the license plate information of the surrounding vehicle before detection of the event information, and
the transmission unit transmits, to the control unit, the license plate information that is recognized before detection of the event information, when the event information is detected.

3. The onboard device according to claim 1, wherein, when the event information is detected, the transmission unit transmits, to the control unit, the license plate information that is recognized by the license plate recognition unit before detection of the event information, and transmits, to the control unit, the license plate information that is recognized by the license plate recognition unit after detection of the event information.

4. A driving recording method comprising:
a step of at least capturing a license plate of a surrounding vehicle from a subject vehicle;
a step of recognizing license plate information from the license plate of the surrounding vehicle that is captured;
a step of detecting event information of the subject vehicle; and
a step of transmitting the license plate information of the surrounding vehicle, identifying the surrounding vehicle from the license plate information of the surrounding vehicle, and transmitting the event information of the subject vehicle for causing control to be performed such that the surrounding vehicle that is identified is caused to record an event image.

5. A driving recording system comprising:
an image capturing unit that captures an image of at least a license plate of a surrounding vehicle from a subject vehicle;
a license plate recognition unit that recognizes license plate information from the license plate of the surrounding vehicle that is captured;
an event information detection unit that detects event information of the subject vehicle;
a transmission unit that transmits the event information of the subject vehicle and the license plate information of the surrounding vehicle to a control unit of a server;
the control unit of the server, the control unit identifying the surrounding vehicle from the license plate information of the surrounding vehicle that is transmitted, and performing control such that the surrounding vehicle that is identified is caused to record an event image of the subject vehicle; and
a recording unit that records, in a non-transitory manner, the event image that is recorded by the surrounding vehicle.
